(19) United States
(12) Patent Application Publication
(10) Pub. No.: US 2010/0055427 A1
(43) Pub. Date: Mar. 4, 2010

(54) Pre-Dipping Carbon Fiber Cloth Structure

(76) Inventor: Chuan-An Hsiao, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/480,906

(22) Filed: Jun. 9, 2009

(30) Foreign Application Priority Data
Aug. 29, 2008 (TW) 097215562

(51) Int. Cl. B32B 5/12; B32B 7/12; B32B 9/00

(52) U.S. Cl. 428/213; 428/221

(57) ABSTRACT

A pre-dipping carbon fiber cloth structure includes a first carbon fiber layer (10) arranged in a regular manner, a second carbon fiber layer (20) combined with the first carbon fiber layer and arranged in an irregular manner and an epoxy resin (11) bonded between the first carbon fiber layer and the second carbon fiber layer. The first carbon fiber layer consists of a plurality of elongate carbon fiber plates (100) which are arranged in a regular manner, and the second carbon fiber layer consists of a plurality of carbon fiber strips (200) which are arranged in an irregular manner. Thus, the first carbon fiber layer and the second carbon fiber layer have the same physical features so that the pre-dipping carbon fiber cloth structure has a better conductance.

### BACKGROUND OF THE INVENTION

1. Field of the Invention

The present invention relates to a cloth and, more particularly, to a pre-dipping carbon fiber cloth structure.

2. Description of the Related Art

A conventional pre-dipping carbon fiber cloth structure in accordance with the prior art shown in FIGS. 4 and 5 comprises a carbon fiber layer 30, a glass fiber layer 31 combined with the carbon fiber layer 30 and a resin 32 bonded between the carbon fiber layer 30 and the glass fiber layer 31. The carbon fiber layer 30 consists of a plurality of elongate carbon fiber plates 300 which are arranged in a regular manner. The glass fiber layer 31 consists of a plurality of lengthwise and crosswise glass fiber plates 310 intersecting each other in a staggered manner.

However, the carbon fiber layer 30 and the glass fiber layer 31 have different physical features so that the pre-dipping carbon fiber cloth structure has a poor conductance. In addition, the carbon fiber layer 30 and the glass fiber layer 31 have different physical features so that when the carbon fiber layer 30 and the glass fiber layer 31 are combined by the resin 32, many bubbles are produced during assembly, thereby decreasing the product quality of the pre-dipping carbon fiber cloth structure. Further, the carbon fiber plates 300 of the carbon fiber layer 30 are arranged in a regular manner so that when the pre-dipping carbon fiber cloth structure is hit or struck by an external force, the force applied on the carbon fiber plates 300 of the carbon fiber layer 30 is not distributed evenly and smoothly, and the carbon fiber plates 300 of the carbon fiber layer 30 are easily worn out or broken due to the external force.

### BRIEF SUMMARY OF THE INVENTION

In accordance with the present invention, there is provided a pre-dipping carbon fiber cloth structure, comprising a first carbon fiber layer arranged in a regular manner, a second carbon fiber layer combined with the first carbon fiber layer and arranged in an irregular manner and an epoxy resin bonded between the first carbon fiber layer and the second carbon fiber layer. The first carbon fiber layer consists of a plurality of elongate carbon fiber plates which are arranged in a regular manner, and the second carbon fiber layer consists of a plurality of carbon fiber strips which are arranged in an irregular manner.

The primary objective of the present invention is to provide a pre-dipping carbon fiber cloth structure having a better conductance and a greater structural strength.

Another objective of the present invention is to provide a pre-dipping carbon fiber cloth structure, wherein the first carbon fiber layer and the second carbon fiber layer have the same physical features so that the pre-dipping carbon fiber cloth structure has a better conductance.

A further objective of the present invention is to provide a pre-dipping carbon fiber cloth structure, wherein the carbon fiber strips of the second carbon fiber layer contact with the carbon fiber plates of the first carbon fiber layer and are arranged in an irregular manner so that when the pre-dipping carbon fiber cloth structure is hit or struck by an external force, the force applied on the carbon fiber plates of the first carbon fiber layer is distributed evenly and smoothly by the carbon fiber strips of the second carbon fiber layer so as to enhance the strength of the pre-dipping carbon fiber cloth structure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pre-dipping carbon fiber cloth structure in accordance with the preferred embodiment of the present invention.

FIG. 2 is an exploded perspective view of the pre-dipping carbon fiber cloth structure as shown in FIG. 1.

FIG. 3 is a front cross-sectional view of the pre-dipping carbon fiber cloth structure as shown in FIG. 1.

FIG. 4 is a perspective view of a conventional pre-dipping carbon fiber cloth structure in accordance with the prior art.

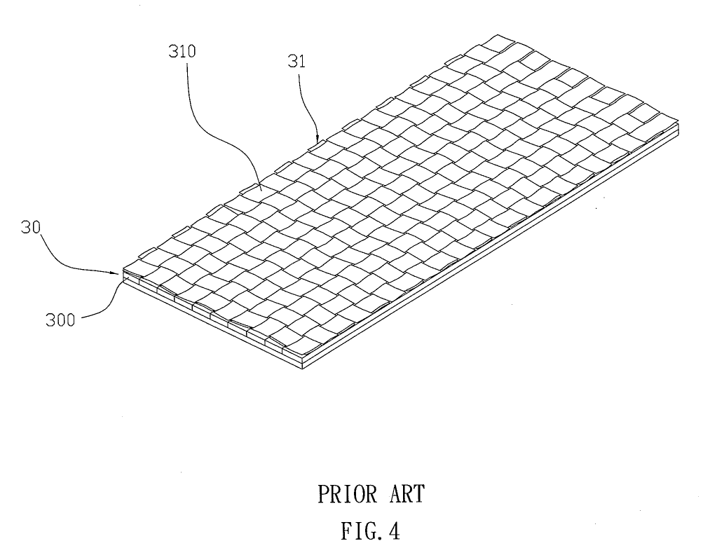

FIG. 5 is an exploded perspective view of the conventional pre-dipping carbon fiber cloth structure as shown in FIG. 4.

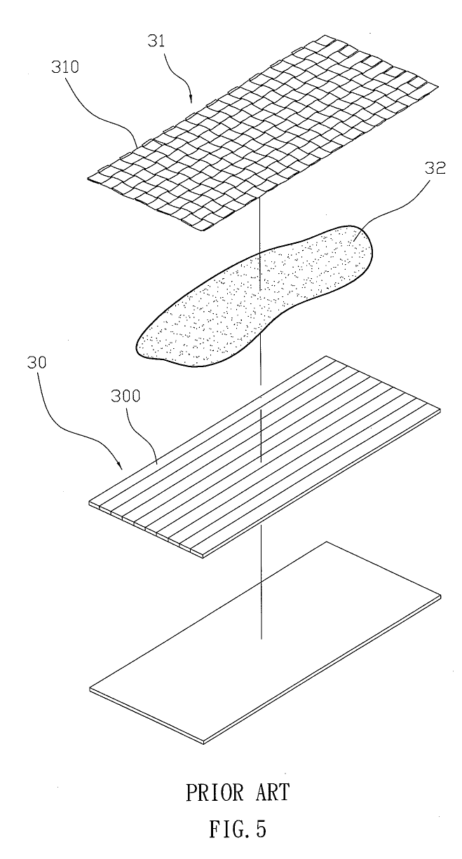

### DETAILED DESCRIPTION OF THE INVENTION

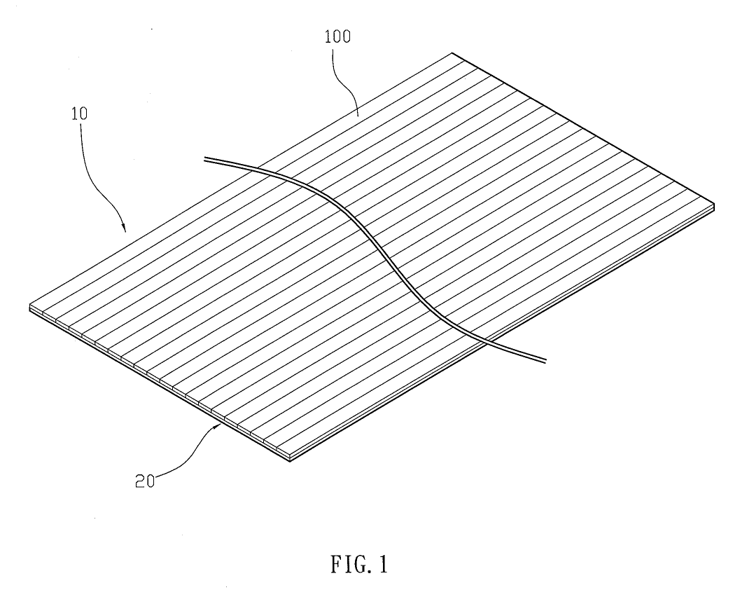

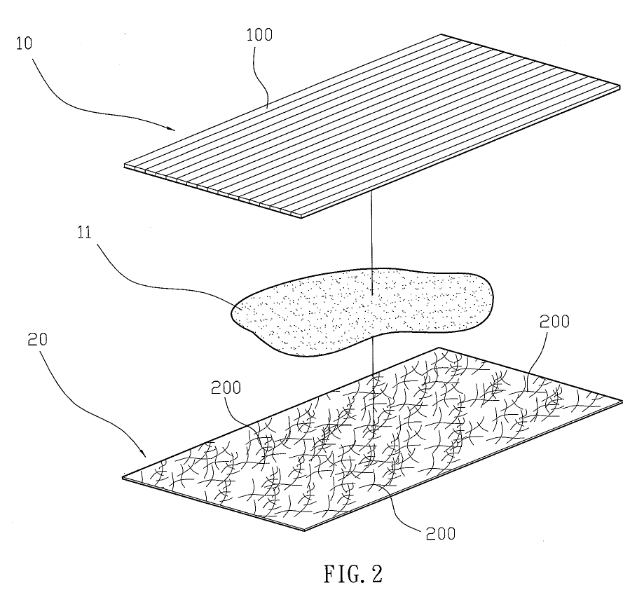

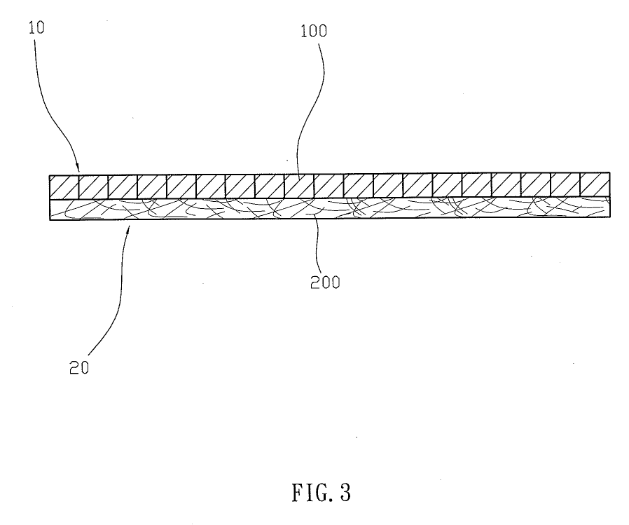

Referring to FIGS. 1-3, a pre-dipping carbon fiber cloth structure in accordance with the preferred embodiment of the present invention comprises a first carbon fiber layer 10 arranged in a regular manner, a second carbon fiber layer 20 combined with the first carbon fiber layer 10 and arranged in an irregular manner, and an epoxy resin 11 bonded between the first carbon fiber layer 10 and the second carbon fiber layer 20.

The first carbon fiber layer 10 is combined with the epoxy resin 11 by dipping. The first carbon fiber layer 10 consists of a plurality of elongate carbon fiber plates 100 which are arranged in a regular manner. The carbon fiber plates 100 of the first carbon fiber layer 10 laminate each other. Each of the carbon fiber plates 100 of the first carbon fiber layer 10 extends in the same direction.

The second carbon fiber layer 20 has a shape and a size matching that of the first carbon fiber layer 10. The second carbon fiber layer 20 consists of a plurality of carbon fiber strips 200 which are arranged in an irregular manner. The carbon fiber strips 200 of the second carbon fiber layer 20 contact with the carbon fiber plates 100 of the first carbon fiber layer 10. The carbon fiber strips 200 of the second carbon fiber layer 20 are combined together by pressing to form the second carbon fiber layer 20. The carbon fiber strips 200 of the second carbon fiber layer 20 extend in different directions. Each of the carbon fiber strips 200 of the second carbon fiber layer 20 extends in a direction different from that each of the carbon fiber plates 100 of the first carbon fiber layer 10. Each of the carbon fiber strips 200 of the second carbon fiber layer 20 has a thickness smaller than that of each of the carbon fiber plates 100 of the first carbon fiber layer 10. Each of the carbon fiber strips 200 of the second carbon fiber layer 20 has an optimum length ranged between 3 mm (millimeter) and 13 mm. Each of the carbon fiber strips 200 of the second carbon fiber layer 20 has an optimum diameter ranged between 5 μm (micrometer) and 10 μm. The second carbon fiber layer 20 has an optimum thickness ranged between 0.02 mm (millimeter) and 0.1 mm. The second carbon fiber layer 20 has an optimum weight ranged between 5 g (gram) and 20 g per square meter.

In assembly, the first carbon fiber layer 10 is combined with the epoxy resin 11 by dipping. Then, the second carbon fiber layer 20 is bonded onto the first carbon fiber layer 10 so that the first carbon fiber layer 10 is combined with the second carbon fiber layer 20 to form the pre-dipping carbon fiber cloth structure.

Accordingly, the first carbon fiber layer 10 and the second carbon fiber layer 20 have the same physical features so that the pre-dipping carbon fiber cloth structure has a better conductance. In addition, the carbon fiber strips 200 of the second carbon fiber layer 20 contact with the carbon fiber plates 100 of the first carbon fiber layer 10 and are arranged in an irregular manner so that when the pre-dipping carbon fiber cloth structure is hit or struck by an external force, the force applied on the carbon fiber plates 100 of the first carbon fiber layer 10 is distributed evenly and smoothly by the carbon fiber strips 200 of the second carbon fiber layer 20 so as to enhance the strength of the pre-dipping carbon fiber cloth structure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pre-dipping carbon fiber cloth structure, comprising:
a first carbon fiber layer (10) arranged in a regular manner;
a second carbon fiber layer (20) combined with the first carbon fiber layer and arranged in an irregular manner;
an epoxy resin (11) bonded between the first carbon fiber layer and the second carbon fiber layer.

2. The pre-dipping carbon fiber cloth structure of claim 1, wherein
the first carbon fiber layer consists of a plurality of elongate carbon fiber plates (100) which are arranged in a regular manner;
the second carbon fiber layer consists of a plurality of carbon fiber strips (200) which are arranged in an irregular manner.

3. The pre-dipping carbon fiber cloth structure of claim 2, wherein each of the carbon fiber strips of the second carbon fiber layer has an optimum length ranged between 3 mm (millimeter) and 13 mm.

4. The pre-dipping carbon fiber cloth structure of claim 2, wherein each of the carbon fiber strips of the second carbon fiber layer has an optimum diameter ranged between 5 μm (micrometer) and 10 μm.

5. The pre-dipping carbon fiber cloth structure of claim 1, wherein the second carbon fiber layer has an optimum thickness ranged between 0.02 mm (millimeter) and 0.1 mm.

6. The pre-dipping carbon fiber cloth structure of claim 1, wherein the second carbon fiber layer has an optimum weight ranged between 5 g (gram) and 20 g per square meter.

7. The pre-dipping carbon fiber cloth structure of claim 2, wherein
each of the carbon fiber plates of the first carbon fiber layer extends in the same direction;
the carbon fiber strips of the second carbon fiber layer extend in different directions.

8. The pre-dipping carbon fiber cloth structure of claim 7, wherein each of the carbon fiber strips of the second carbon fiber layer extends in a direction different from that each of the carbon fiber plates of the first carbon fiber layer.

9. The pre-dipping carbon fiber cloth structure of claim 2, wherein the carbon fiber strips of the second carbon fiber layer contact with the carbon fiber plates of the first carbon fiber layer.

10. The pre-dipping carbon fiber cloth structure of claim 2, wherein the carbon fiber strips of the second carbon fiber layer are combined together by pressing to form the second carbon fiber layer.

11. The pre-dipping carbon fiber cloth structure of claim 2, wherein each of the carbon fiber strips of the second carbon fiber layer has a thickness smaller than that of each of the carbon fiber plates of the first carbon fiber layer.

12. The pre-dipping carbon fiber cloth structure of claim 1, wherein the second carbon fiber layer has a shape and a size matching that of the first carbon fiber layer.

13. The pre-dipping carbon fiber cloth structure of claim 12, wherein the carbon fiber plates of the first carbon fiber layer laminate each other.
